(19) United States
(12) Patent Application Publication
(10) Pub. No.: US 2026/0107088 A1
(43) Pub. Date: Apr. 16, 2026

(54) PLAYBACK DEVICE SUBSTRATES

(71) Applicant: Sonos, Inc., Goleta, CA (US)

(72) Inventors: Kylie Muntean, Santa Barbara, CA (US); Kevin Ash, Boston, MA (US); Wei Hean Liew, Boston, MA (US); Jen Chieh Tsai

(21) Appl. No.: 19/113,086

(22) PCT Filed: Sep. 20, 2022
(86) PCT No.: PCT/CN2022/119883

§ 371 Date: Mar. 19, 2025

(51) Int. Cl. H04R 1/34; G06F 3/16; H04R 1/02; H04R 1/24

(52) U.S. Cl. CPC H04R 1/345; G06F 3/165; H04R 1/023; H04R 1/025; H04R 1/24

(57) ABSTRACT

Substrates for playback devices and playback devices incorporating same. In one example, a playback device includes an audio transducer, a grille laterally overlaying the audio transducer, wherein the grille has a first thickness and includes a first perforated region having a first plurality of apertures extending through the grille, and a substrate disposed between the audio transducer and the grille, wherein the substrate has a second thickness greater than the first thickness, and wherein the substrate includes a second perforated region having a second plurality of apertures extending through the substrate, the second perforated region defining an acoustic filter configured to modify a radiation pattern of an acoustic output from the audio transducer.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### SUMMARY

Aspects and embodiments are directed to structural support substrates for playback devices that are configured to also advantageously impact the directivity of the sound output via the playback device transducer, and to playback devices incorporating such substrates.

According to one embodiment, a playback device, comprises an audio transducer, a grille laterally overlaying the audio transducer, wherein the grille has a first thickness and includes a first perforated region having a first plurality of apertures extending through the grille, and a substrate disposed between the audio transducer and the grille, wherein the substrate has a second thickness greater than the first thickness, and wherein the substrate includes a second perforated region having a second plurality of apertures extending through the substrate, the second perforated region defining an acoustic filter configured to modify a radiation pattern of an acoustic output from the audio transducer.

In certain examples, each aperture of the first plurality of apertures has a first radius, wherein each aperture of at least a subset of the second plurality of apertures has a second radius, and wherein the first radius is less than the second radius. In one example, the second radius is in a range of 1 millimeter to 1.5 millimeters.

In some examples, the second perforated region has a lateral width that is less than an outer diameter of the audio transducer. In some examples, the second perforated region extends laterally beyond an outer rim of the audio transducer.

In certain examples, each aperture of the second plurality of apertures has a maximum lateral dimension in a range of 2.5 to 3.75 times a maximum lateral dimension of each aperture of the first plurality of apertures.

In certain examples, the first plurality of apertures are spatially staggered with respect to the second plurality of apertures. In other examples, the first plurality of apertures is axially aligned with respect to the second plurality of apertures.

In one example, the first thickness is 1 millimeter.

The grille may be made of plastic, for example.

In some examples, the substrate is made of glass-filled polycarbonate with a glass content in a range of 30%-40%.

In some examples, the substrate is curved.

The playback device may further comprise a housing at least partially surrounding the audio transducer, wherein the substrate is coupled to the housing, and wherein the grille extends around at least a portion of the housing.

In some examples, the substrate includes first and second solid body regions, the second perforated region being disposed laterally between the first and second solid body regions.

According to one embodiment, a playback device comprises a housing, a first audio transducer configured to produce a first acoustic output according to a first radiation pattern in a first frequency range, a second audio transducer configured to produce a second acoustic output according to a second radiation pattern in a second frequency range lower in frequency than the first frequency range, a grille extending around at least a portion of the housing, the grill including a first perforated region having a first plurality of apertures extending through the grille, and an acoustic filter coupled to the housing and configured to modify a shape of at least one of the first radiation pattern and the second radiation pattern, the acoustic filter including a substrate having a second perforated region that defines a slot of the acoustic filter, the second perforated region including a second plurality of apertures extending through the substrate. The substrate may be coupled to the housing and positioned with the second perforated region disposed in front of the second audio transducer to allow the second acoustic output to pass through the second perforated region. The grille may be positioned with a portion of the first perforated region overlaying the second perforated region of the substrate.

In certain examples, the housing includes a first end portion, a second end portion, and a frame therebetween, and wherein the first and second audio transducers are mounted to the frame.

In some examples, the first frequency range includes audible frequencies above 2 kilohertz, and wherein the second frequency range includes audible frequencies below 500 hertz.

In some examples, the substrate has a curved surface, the first perforated region being formed in the curved surface. The substrate may include first and second solid body portions positioned on either side of the first perforated region and extending laterally around the second audio transducer, the first audio transducer being positioned at least partially above the first solid body portion. In some examples, the substrate is configured such that the acoustic filter provides greater than 180 degrees dispersion of the first acoustic output. In certain examples, the first plurality of apertures are arranged in a pattern that is radially smooth to the first acoustic output. Each aperture of the second plurality of apertures may have a maximum lateral dimension in a range of 2-3 millimeters, for example. In one example, each aperture of the second plurality of apertures is round and wherein the maximum lateral dimension is a diameter of the respective aperture.

In certain examples, the substrate is made of glass-filled polycarbonate with a glass content in a range of 30%-40%.

In some examples, a lateral width of the slot is less than an outer diameter of the second audio transducer.

In some examples, the grille has a first axial thickness and wherein the substrate has a second axial thickness that is greater than the first axial thickness. In one example, the first axial thickness is 1 millimeter. In one example, the second axial thickness is 3 millimeters.

The grille may be made of plastic, for example.

According to another embodiment, a playback device comprises a housing, a first audio transducer configured to produce a first acoustic output in a first frequency range, a second audio transducer configured to produce a second acoustic output in a second frequency range lower in frequency than the first frequency range, a grille laterally overlaying the first and second audio transducers and extending around at least a portion of the housing, wherein the grille includes a first perforated region having a first plurality of apertures extending through the grille, and a substrate axially disposed between the second audio transducer and the grille and coupled to the housing, wherein the substrate includes a second perforated region including a second plurality of apertures extending through a surface of the substrate and collectively defining an acoustic filter slot having a lateral width and a height, the lateral width being less than an outer diameter of the second audio transducer. The substrate may be positioned with the second perforated region overlaying the second audio transducer, and the grille may positioned with a portion of the first perforated region overlaying the second perforated region of the substrate.

In some examples, the surface of the substrate is curved. The substrate may further include first and second solid body regions disposed laterally on either side of the second perforated region, the substrate being configured as a slot-loaded acoustic filter that modifies dispersion of each of the first and second acoustic outputs. In one example, the first and second solid body portions extend laterally around the second audio transducer. In certain examples, the slot-loaded acoustic filter provides greater than 180 degrees directivity of the first acoustic output.

In some examples, the substrate is made of glass-filled polycarbonate with a glass content in a range of 30%-40%.

In some examples, the second plurality of apertures are arranged in a pattern that is radially smooth to the first acoustic output.

In some examples, each aperture of the second plurality of apertures has a maximum lateral dimension in a range of 2-3 millimeters. In one example, the maximum lateral dimension of each aperture is a diameter of the aperture.

In some examples, the lateral width of the acoustic filter slot is less than an outer diameter of the second audio transducer.

In some examples, the grille has a first axial thickness and wherein the substrate has a second axial thickness that is greater than the first axial thickness. In one example, the first thickness is 1 millimeter and the second thickness is 3 millimeters.

In some examples, the housing includes a first end portion, a second end portion, and a frame therebetween, wherein the first and second audio transducers are mounted to the frame.

In some examples, the first frequency range includes audible frequencies above 2 kilohertz, and the second frequency range includes audible frequencies below 500 hertz.

In some examples, the grille is made of plastic.

According to another embodiment, a playback device comprises a housing, a first audio transducer configured to produce a first acoustic output in a first frequency range, a second audio transducer configured to produce a second acoustic output in a second frequency range lower in frequency than the first frequency range, a grille extending around at least a portion of the housing and overlaying the first and second audio transducers, the grille including a first perforated region with a first plurality of apertures extending through the grille, and a unified dual-band slot-loaded filter coupled to the housing and axially disposed between the second audio transducer and the grille, wherein the unified dual-band slot-loaded filter is configured to modify directivity of each of the first and second acoustic outputs and includes a slot overlaying the second audio transducer, the slot being defined by a second plurality of apertures arranged in a pattern in a body of the unified dual-band slot-loaded filter, and wherein an outer rim of the second audio transducer extends laterally beyond a boundary of the slot.

In one example, the first frequency range includes audible frequencies above 2 kilohertz, and wherein the second frequency range includes audible frequencies below 500 hertz.

The grille may be made of plastic, for example.

In certain examples, the second plurality of apertures are arranged in a pattern that is radially smooth to the first acoustic output.

In some examples, each aperture of the second plurality of apertures has a maximum lateral dimension in a range of 2-3 millimeters.

According to another embodiment, a unified dual-band slot-loaded acoustic filter for a playback device comprises a substrate made of a rigid material, the substrate including a central slot formed therein, the slot being defined by a plurality of apertures arranged in a regular pattern with a pitch between adjacent apertures in a range of x-y millimeters and extending through the substrate, each aperture of the plurality of apertures having a diameter in a range of 2-3 millimeters, and a lateral width of the slot selected to provide at least 180 degrees directivity of an acoustic wave having a frequency of 2 kHz.

In one example, the substrate is made of glass-filled polycarbonate with a glass content in a range of 30%-40%.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRA WINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

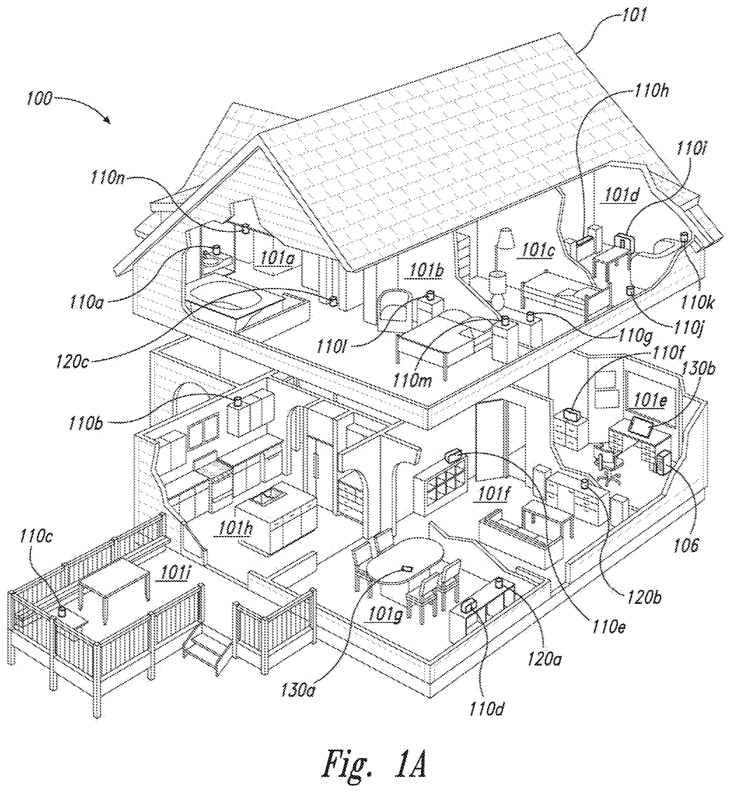

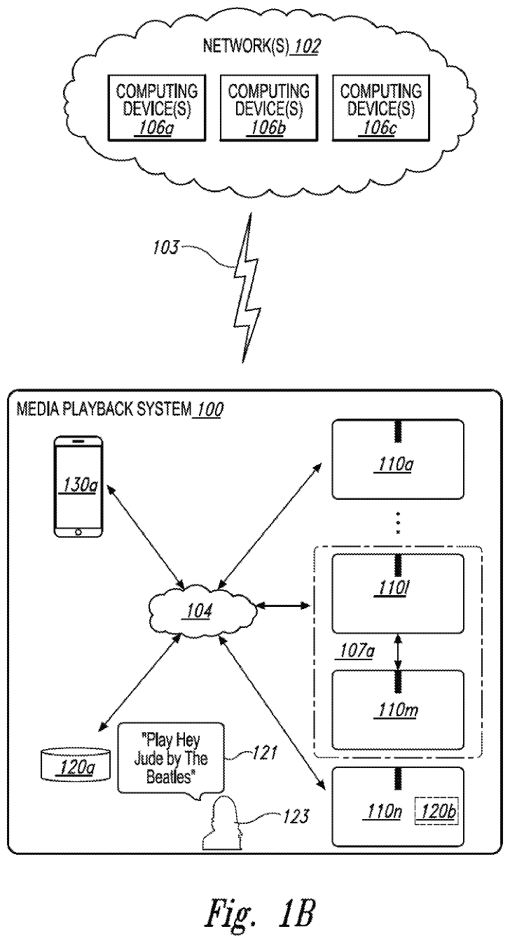

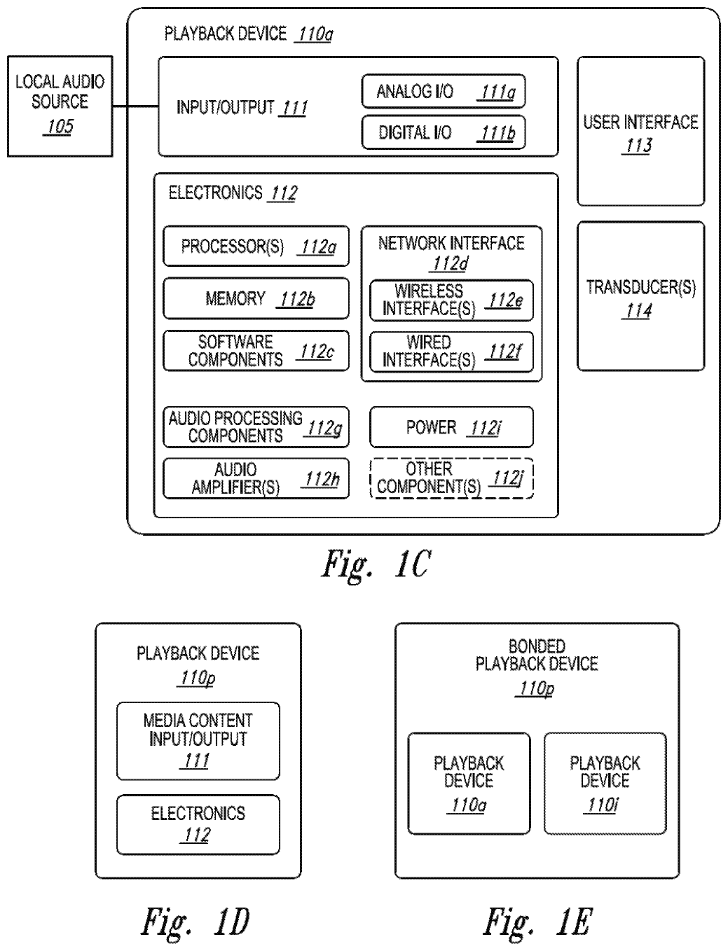

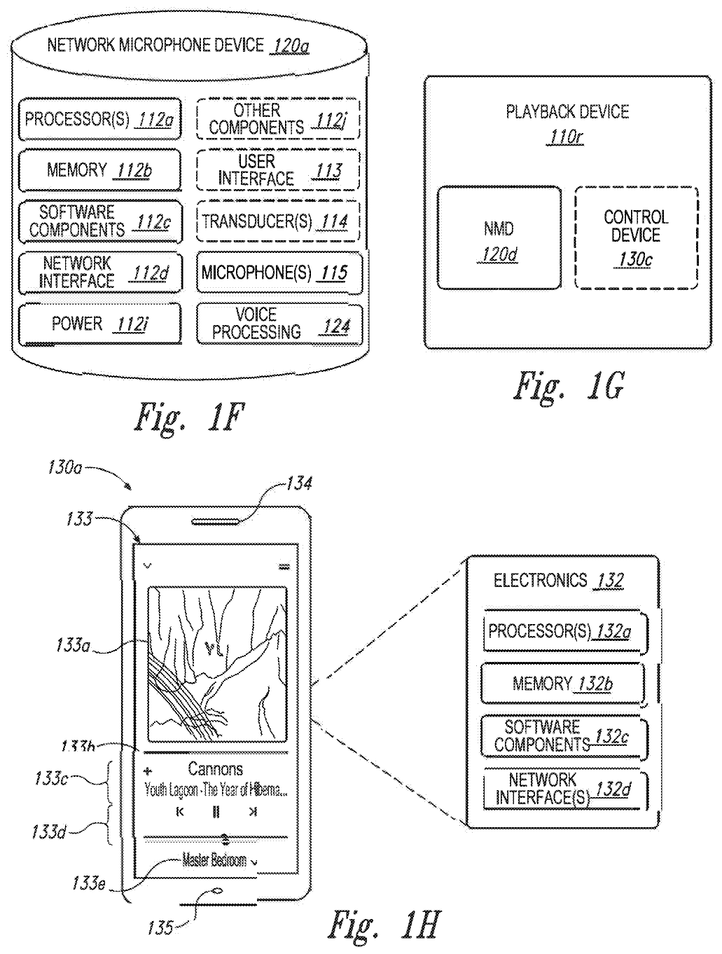

FIG. 1A is a partial cutaway view of an environment having a media playback system configured in accordance with aspects of the disclosed technology;

FIG. 1B is a schematic diagram of the media playback system of FIG. 1A and one or more networks;

FIG. 1C is a block diagram of a playback device;

FIG. 1D is a block diagram of a playback device;

FIG. 1E is a block diagram of a bonded device;

FIG. 1F is a block diagram of a network microphone device;

FIG. 1G is a block diagram of a playback device;

FIG. 1H is a partial schematic diagram of a control device;

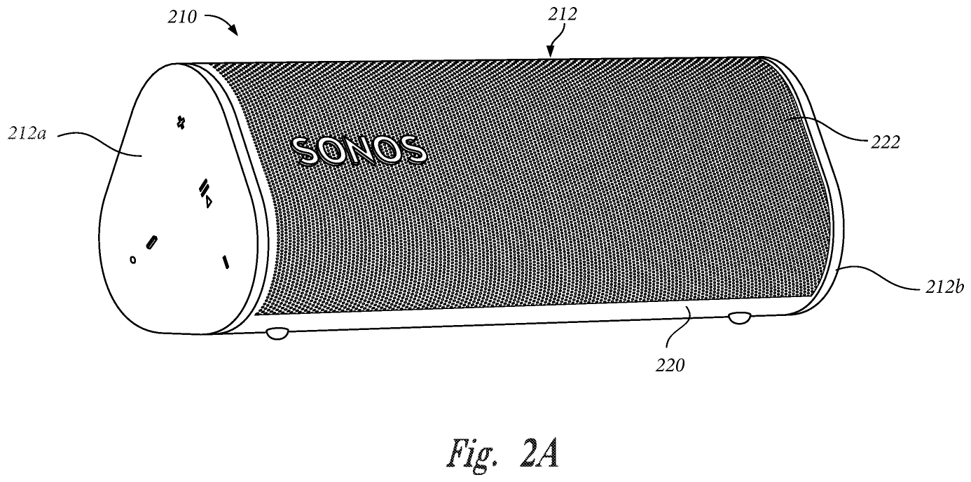

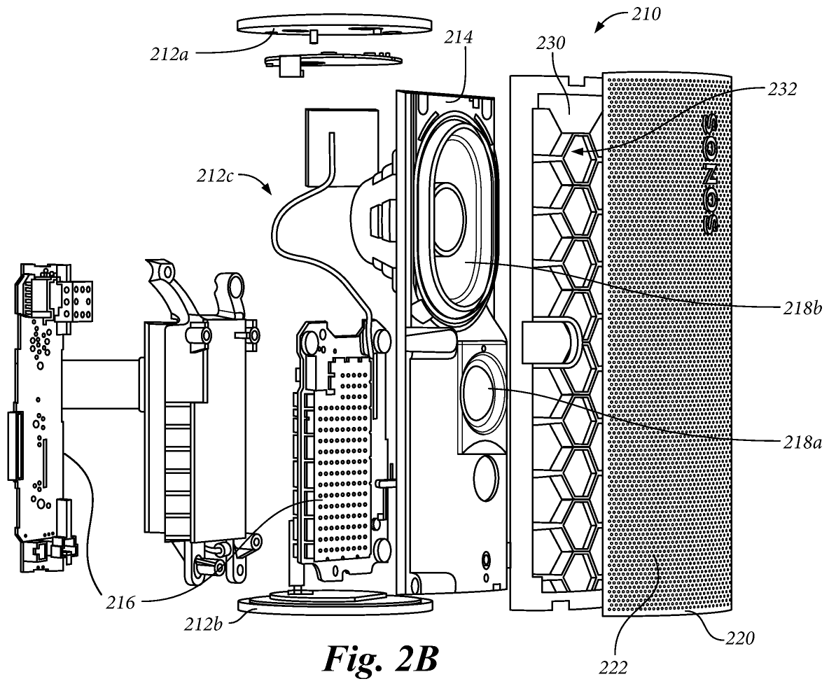

FIG. 2A is a front isometric view of one example of a playback device;

FIG. 2B is a partial exploded view of the playback device of FIG. 2A;

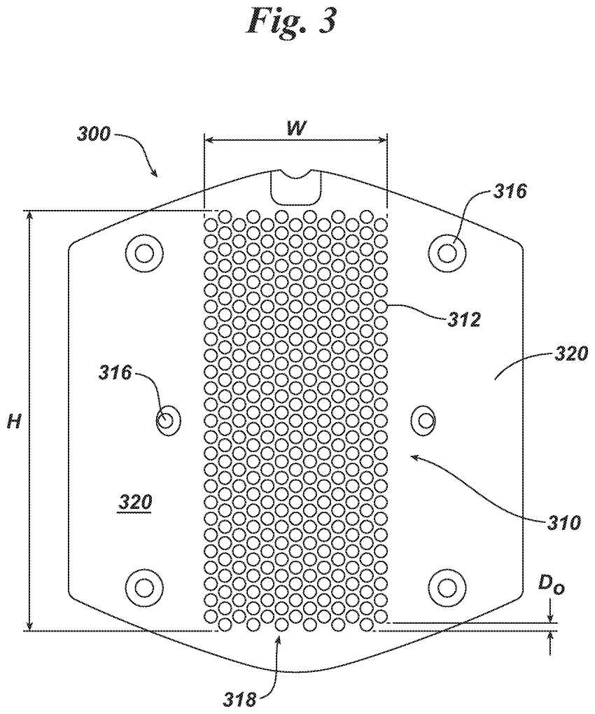

FIG. 3 is a front plan view of one example of a playback device substrate configured in accordance with aspects of the disclosed technology;

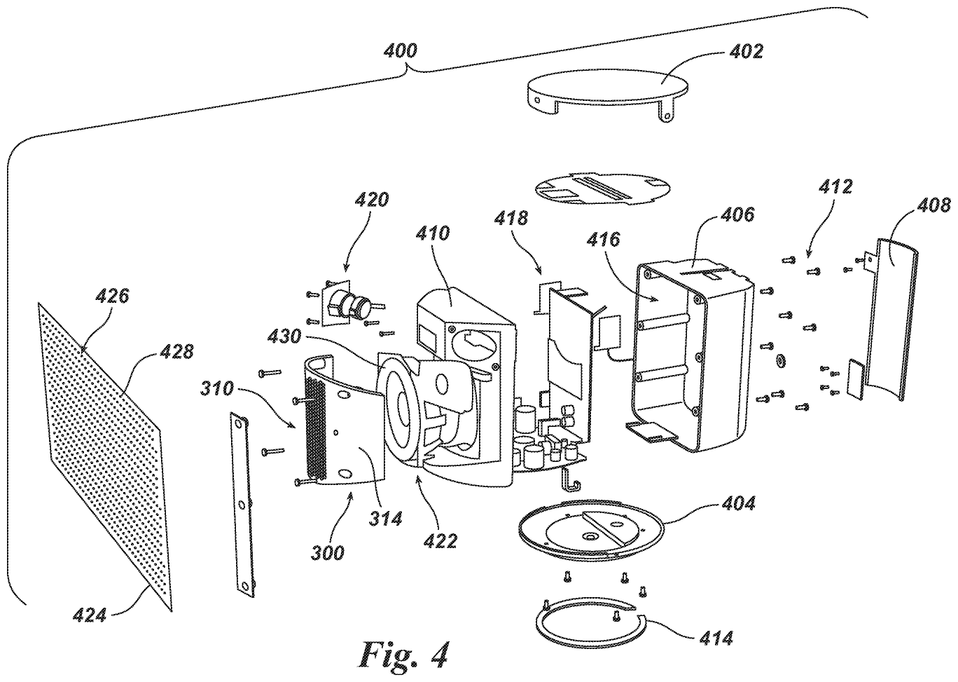

FIG. 4 is a partial exploded view of one example of a playback device configured in accordance with aspects of the disclosed technology;

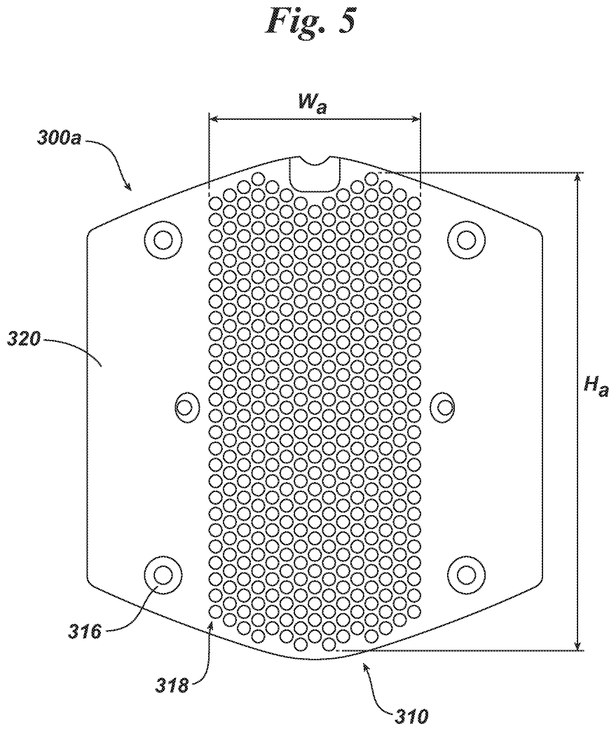

FIG. 5 is a front plan view of another example of a playback device substrate configured in accordance with aspects of the disclosed technology;

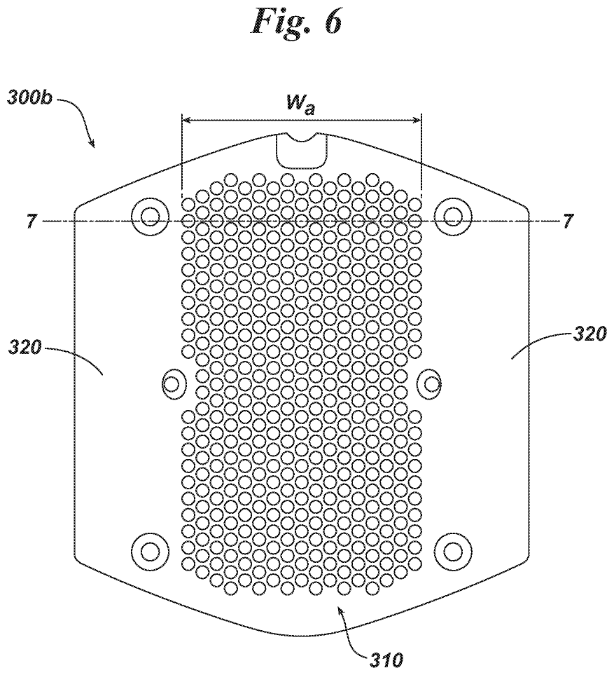

FIG. 6 is a front plan view of another example of a playback device substrate configured in accordance with aspects of the disclosed technology; and

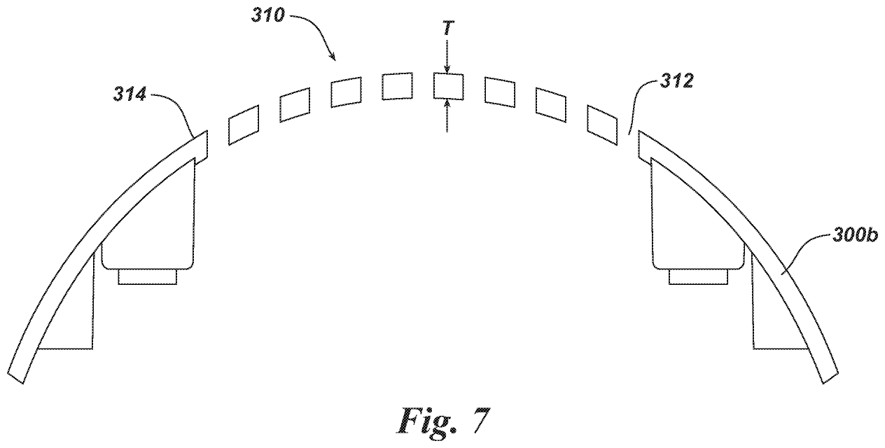

FIG. 7 is a cross-sectional plan view of a portion of the playback device substrate of FIG. 6, taken along line 7-7 in FIG. 6.

### DETAILED DESCRIPTION

### I. Overview

Audio playback devices often include a grille disposed over the face of an acoustic transducer (e.g., a speaker) to protect the transducer and other internal components from damage while still allowing sound to pass through without significant distortion. Soft grilles can take the form of woven cloth or fabric, while hard grilles can take the form of perforated metal or plastic sheets defining a plurality of holes. In some instances, these grilles may be very thin (e.g., less than 2 millimeters (mm) in thickness). Accordingly, playback devices incorporating thin outer grilles may also include an intermediate substrate positioned between the grille and the transducer(s). The substrate provides structural support for the grille while also assisting in preventing objects from intruding toward the transducer(s). Typically, the acoustic impact of the substrate is negligible. For example, as discussed further below, the substrate may be formed with a “honeycomb” type structure having large voids that are essentially acoustically transparent.

According to various aspects and embodiments, there are provided playback devices with substrates that, rather than being acoustically transparent, are configured to act as acoustic filters in a manner that enhances the user experience of the sound output from the playback device. As discussed in more detail below, according to certain aspects, the substrate can be leveraged to beneficially impact the directivity of the sounds output via the transducer(s) and thus desirably improve the perceived sound “width” or “immersiveness” experienced by the user. Instead of the “honeycomb” configuration, examples of the substrates disclosed herein include a perforated region having a pattern of apertures in the substrate body, the apertures being small holes rather than large voids. As discussed further below, according to certain examples, the perforated region of the substrate effectively serves as a slot-type filter, similar to a slot-loaded waveguide, that can result in wider directivity and greater midband efficiency of the acoustic output than would be achieved with a conventional substrate.

According to certain embodiments, a playback device comprises an audio transducer, a grille laterally overlaying the audio transducer, the grille having a first thickness and including a first perforated region having a first plurality of apertures extending through the grille, and a substrate disposed between the audio transducer and the grille. The substrate has a second thickness greater than the first thickness, and includes a second perforated region having a second plurality of apertures extending through the substrate, the second perforated region defining an acoustic filter configured to modify a radiation pattern of an acoustic output from the audio transducer. Further features, aspects and embodiments of the playback device are discussed in more detail below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip-hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety for all purposes.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for example, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the playback devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media playback system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some examples, the playback device 110a optionally includes one or more microphones 115 (e.g., a single microphone, a plurality of microphones, a microphone array) (hereinafter referred to as “the microphones 115”). In certain examples, for example, the playback device 110a having one or more of the optional microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which is incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “MOVE,” “PLAY:5,” “BEAM,” “PLAYBAR,” “PLAYBASE,” “PORT,” “BOOST,” “AMP,” and “SUB.” Other suitable playback devices may additionally or alternatively be used to implement the playback devices of example examples disclosed herein. Additionally, one of ordinary skilled in the art will appreciate that a playback device is not limited to the examples described herein or to SONOS product offerings. In some examples, for example, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some examples, for instance, the playback device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some examples, the NMD 120a is configured as a media playback device (e.g., one or more of the playback devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™ an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™ an Android phone). In some examples, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Examples of Playback Devices and Associated Systems and Methods

FIG. 2A is a front isometric view of a playback device 210 configured in accordance with examples of the disclosed technology. The playback device 210 may be used as any of the playback devices 110 discussed above. FIG. 2B is a partial exploded view of the playback device 210. Referring to FIGS. 2A and 2B together, the playback device 210 comprises a housing 212 that includes an upper portion 212a and a lower portion 212b. A grille 220 may form part of the housing 212 or may overlay an underlying portion of the housing 212. In some examples, the housing 212 can take the form of an enclosure that defines an interior cavity 212c within which various components of the playback device 210 are housed. In the illustrated example, the housing 212 forms a generally triangular prism shape having rounded edges. However, the particular shape and dimensions of the housing 212 can vary in different implementations. For example, the housing 212 can be generally cylindrical, spherical or oblate spheroid shape, and can have one or more edges that are rounded or sharp. The interior cavity 212c in the housing 212 is configured to receive a frame 214 and electronics 216. The frame 214 is configured to carry a plurality of transducers 218 (identified individually in FIG. 2B as transducers 218a and 218b). The electronics 216 (e.g., the electronics 112 of FIG. 1C) are configured to receive audio content from an audio source and send electrical signals corresponding to the audio content to the transducers 218 for playback.

The transducers 218 are configured to receive the electrical signals from the electronics 216, and further configured to convert the received electrical signals into audible sound during playback. For instance, the transducer 218a (e.g., a tweeter) can be configured to output high frequency sound (e.g., sound waves having a frequency greater than about 2 kHz). The transducer 218b (e.g., a mid-woofer, woofer, or midrange speaker) can be configured output sound at frequencies lower than the transducer 218a (e.g., sound waves having a frequency lower than about 2 kHz). In some examples, the playback device 210 includes a number of transducers different than those illustrated in FIG. 2B. For example, the playback device 210 can include only a single transducer 218 or may include more than two transducers (e.g., six, nine, ten, etc.). Moreover, in some examples, all or a portion of the transducers 218 are configured to operate as a phased array to desirably adjust (e.g., narrow or widen) a radiation pattern of the transducers 218, thereby altering a user's perception of the sound emitted from the playback device 210.

As illustrated in FIGS. 2A and 2B, in certain embodiments, the grille 220 extends between the upper portion 212a and the lower portion 212b. The grille 220 can be implemented in a variety of ways. In some examples, the grille 220 can take the form of a sheet, which may be formed of one or more layers of materials. For example, the grille 220 may be a metallic sheet or a thin sheet of plastic. In certain examples, the grille 220 is coupled to and supported by an underlying substrate 230. The substrate 230 can be coupled to the housing 212, allowing for the grille 220 to surround at least a portion of the housing 212 between the upper portion 212a and the lower portion 212b. In certain examples, the substrate 230 includes a region with several openings 232 formed in the substrate 230 and the grille 220 includes a perforated portion 222 having a plurality of small holes formed in the grille 220. As shown, in some examples the openings 232 in the substrate 230 can be much larger than the holes in the perforated portion 222 of the grille 220. When the grille 220 is coupled to the housing 212, the openings 232 and the perforated portion 222 can overlay the transducers 218.

The grille 220 and the substrate 230 protect the internal components of the playback device 210 (e.g., the audio transducers 218 and the electronics 216) from damage while still allowing sound from the audio transducers 218 to pass through without significant distortion or attenuation. The grille 220 prevents debris from entering the housing 212 and damaging the transducers 218 and electronics 216. The substrate 230 provides additional structural integrity to the grille 220, which reduces the amount of physical damage the playback device 210 receives from an accident (such as dropping the playback device 210) or other event. Because the region of the substrate 230 with the openings 232 and the perforated portion 222 of the grille 220 overlay the transducers 218 when the grille 220 and substrate 220 are coupled to the housing 212, sound outputted from the transducers 218 can pass through the grille 220 without significant distortion or attenuation.

In various embodiments of the playback devices 110, including the example of the playback device 210 shown in FIGS. 2A and 2B, the substrate 230 has a “honeycomb” structure in the region with the openings 232, the openings 232 being sufficiently large that they have negligible acoustic impact (or no acoustic impact at all) on the sound waves emitted by the transducers 218. In these examples, the substrate 230 provides structural support for the grille 220, but is acoustically “transparent”to the transducers 218.

As discussed above, according to various aspects and embodiments disclosed herein, rather than being acoustically transparent like the substrate 230, a substrate can be configured to provide an acoustic function as well as providing structural support for the grille 220. An example of such a substrate is illustrated in FIG. 3.

Referring to FIG. 3, a substrate 300 according to certain embodiments includes a perforated region 310 that includes a plurality of apertures 312 arranged in a pattern. Each of the apertures 312 defines a small hole that extends through the substrate 300. Unlike the large openings 232 in the substrate 230, the size of the apertures 312 is selected to be in a range that causes the perforated region to have an acoustic effect rather than being essentially acoustically transparent. In particular, as discussed further below, the plurality of apertures 312 together can act as a slot-type acoustic filter that modifies the directivity and efficiency of the sound waves passing through the perforated region 310. In the example illustrated in FIG. 3, the apertures 312 are round holes; however, in other examples, the apertures 312 may have other shapes, including, but not limited to, oval, hexagonal, rectangular, and the like. The perforated region 310 may have a lateral width, W, and a height, H, measured in a dimension orthogonal to the lateral width, as shown in FIG. 3. As discussed further below, the perforated region 310 may be configured, for example, through appropriate selection of the height, H, width, W, and number, size, and arrangement of the apertures 312, to act as an acoustic filter, allowing sound waves from an audio transducer to pass through, while also advantageously modifying the directivity of those sound waves as they pass over the substrate 300 and through the apertures 312.

FIG. 4 is a partial exploded view of an example of a playback device 400 incorporating an example of the substrate 300 according to certain embodiments. The playback device 400 may be used as any of the playback devices 110 discussed above (FIGS. 1A-1G). The playback device 400 comprises a housing that includes a top portion 402, a bottom portion 404, a rear enclosure 406, a rear panel 408, and a frame 410. The rear enclosure 406 and the frame 410 extend between the top portion 402 and the bottom portion 404. The rear enclosure 406 may be fastened to the frame 410, for example, using a plurality of fasteners, such as screws or other fasteners. Similarly, the rear panel 408 may be fastened to the rear enclosure using screws or other fasteners 412. In some examples, a foot 414, such as a rubber foot or foot made of a soft plastic, for example, may be secured to the underside of the bottom portion 404. The rear enclosure 406 defines an internal cavity 416 configured to receive electronics 418. The frame 410 is configured to carry at least a first audio transducer 420 and a second audio transducer 422. As discussed above with reference to FIGS. 2A and 2B, the electronics 418 (e.g., the electronics 112 of FIG. 1C or electronics 216 of FIG. 2B) are configured to receive audio content from an audio source and send electrical signals corresponding to the audio content to the audio transducers 420, 422 for playback. Although only two audio transducers 420, 422 are shown in FIG. 4, in other examples, the playback device 400 may include one or more additional audio transducers. The substrate 300 may be positioned at least partially surrounding the second audio transducer 422, with the perforated region 310 positioned in front of, or overlaying, the second audio transducer 422, as shown in FIG. 4. The substrate 300 may include a plurality of mounting apertures 316 (see FIG. 3, for example) to allow the substrate to be coupled to (e.g., fastened using screws or other fasteners) the frame 410 and/or other components of the housing the playback device 400. The playback device 400 may further include a grille 424 that overlays the substrate 300, similar to the arrangement and function discussed above with references to FIGS. 2A and 2B.

As discussed above, the grille 424 includes a perforated region 426 having a plurality of apertures 428 extending therethrough. The grille 424 can be positioned such that a portion of the perforated region 426 overlays the perforated region 310 of the substrate 300. A portion of the perforated region 426 of the grille 424 may also overlay the first audio transducer 420. Sound outputted from the audio transducers 420, 422 can pass through the perforated region 426 of the grille 424 without significant distortion or attenuation. As discussed above, the grille 424 may take the form of a thin sheet including one or more layers of material. For example, the grille 424 may include a thin sheet of metal or plastic, for example, in a range of about 0.5 millimeters (mm) to 2 mm in thickness, optionally about 1 mm in thickness. In such cases where the grille 424 is very thin, the substrate 300 may provide structural support for the grille 424 as well as providing mechanical protection for underlying components of the playback device 400, such as, for example, the second audio transducer 424 and/or various components of the electronics 418. Accordingly, the substrate 300 may be made of a rigid material, such as a rigid plastic, for example, that can provide the desired mechanical support and protection. In certain examples, the substrate 300 is made of polycarbonate, optionally a glass-filled polycarbonate. In some examples, the substrate 300 is made of a glass-filled polycarbonate with a glass content in a range of 30%-40%. However, those skilled in the art will appreciate, given the benefit of this disclosure, that the substrate 300 may be made of any material that can suitably provide the desired structural support and which can be processed to form the plurality of apertures 312 to produce the perforated region 310.

As discussed above, the playback device 400 may be configured to receive audio content from an audio source and playback the audio content via sound waves output from the audio transducers 420, 422. The audio transducers 420, 422 may each provide an acoustic output in a particular range of audible frequencies. For example, the first audio transducer 420 may be a “tweeter” and can be configured to output high frequency sound (e.g., sound waves having a frequency greater than about 2 kHz). The second audio transducer 422 may be a “woofer” and can be configured output sound at frequencies lower than the first audio transducer 420 (e.g., sound waves having a frequency lower than about 2 kHz, and optionally sound waves having audible frequencies below 500 Hz). In the illustrated example of FIG. 4, the second audio transducer 422 has a single diaphragm driven by a single motor (not shown). In some examples, however, the playback device 400 comprises one or more dual diaphragm transducers such as those described in U.S. Pat. No. 11,297,415, which is herein incorporated by reference in its entirety for all purposes.

In many examples it may be desirable for the playback device 400 to provide an acoustic output with a very wide radiation pattern, such that a listener does not hear a significant difference in the sound when the user is directly in front of the playback device 400 versus being to one side of the playback device 400, and thus perceives the sound with a high degree of immersiveness. The audio transducers 420, 422 may be designed to produce first and second acoustic outputs, respectively, with relatively wide directivity; however, according to certain embodiments disclosed herein, the substrate 300 can be configured to further widen the radiation pattern of at least the second audio transducer 422 and thereby enhance the perceived immersiveness of the sound output from the playback device 400. As discussed further below, according to certain examples, the substrate 300 can be configured with respect to, among other features, the width, W, of the perforated region 310, the height, H, of the perforated region 310, the number of apertures 312, the size of the apertures 312, the arrangement of the apertures 312 (e.g., pattern, and pitch or spacing between apertures), and the thickness of the substrate 300 in the perforated region 310, which corresponds to the depth of the apertures 312.

Still referring to FIGS. 3 and 4, the substrate 300 is positioned with the perforated region 310 overlaying the second audio transducer 422. As such, the second acoustic output from the second audio transducer 422 passes through the perforated region 310 of the substrate 300. The plurality of apertures 312 together can act as a “slot” that widens the directivity of the second acoustic output from the second audio transducer as it passes through the perforated region 310. In this manner, the substrate 300 may serve as an acoustic filter with a slot-loading effect that modifies the radiation pattern of the second audio transducer 422. To achieve the desired filtering effect, the lateral width, W, of the perforated region 310 may be selected based at least in part on the frequency range of the second acoustic output from the second audio transducer 422. In some examples, where the frequency range of the second acoustic output of the second audio transducer 422 includes audible frequencies below, for instance, 2 kHz, the width, W, may be in a range of about 40 mm to 55 mm, optionally, in a range of 44.6 mm to 51.4 mm. In some examples, the width, W, may be selected such that the perforated region 310 is narrower than the outer diameter of the second audio transducer 422. In other examples, the width, W, may be selected such that the perforated region 310 extends laterally to, or beyond, an outer rim 430 of the second audio transducer 422.

According to certain embodiments, the substrate 300 can be configured as a unified dual-band acoustic filter, modifying the radiation patterns of both the first audio transducer 420 and the second audio transducer 422. In such examples, the perforated region 310 acts as a slot-type filter that modifies the radiation pattern of the second audio transducer 422, while the shape and configuration of the substrate 300 can be selected to also enhance the first acoustic output of the first audio transducer 420. For example, as discussed further below, the substrate 300 can be configured to enhance the smoothness and consistency of the first acoustic output from the first audio transducer 420 while simultaneously widening the directivity of the second acoustic output from the second audio transducer 422 through the effect of the perforated region 310. In certain examples, the substrate 300 can be further configured to also widen the directivity of the first acoustic output from the first audio transducer 420.

As shown in FIG. 3, the substrate 300 may include solid body portions 320 on either side of the perforated region 310. In certain configurations of the playback device 400, and where the first audio transducer is a tweeter, the first audio transducer 420 may be configured to radiate out of a very small slot such that the first acoustic output has very wide directivity. The sound waves corresponding to the first acoustic output may travel along the surface of the solid body portions 320 and across the perforated region 310. To maintain the smoothness and consistency in the sound waves of the first acoustic output, the plurality of apertures 312 can be arranged in a pattern that is radially smooth to the first acoustic output. To this end, the apertures 312 may be small, for example, having a maximum lateral dimension in a range of 0.5 mm-6 mm, optionally in a range of 0.5 mm-3 mm, and further optionally in a range of 1 mm-3 mm, and arranged in a regular pattern to avoid presenting large discontinuities to the first acoustic output. In certain examples, it may be preferable to keep a diameter of the apertures 312 to 3 mm or less, for example, in a range of 2 mm-3 mm, to meet certain regulatory requirements, such as fire safety standards, that may apply to the playback device 400 (or some components thereof) and thereby avoid the need for other components to be added and/or modified to meet such requirements.

In the example shown in FIG. 3, the plurality of apertures 312 are arranged in a plurality of columns 318. The columns may be staggered with respect to one another, with an offset, D₀, between adjacent columns. The apertures 312 may be arranged with a center-to-center spacing between adjacent apertures (pitch). In certain examples, the pitch and/or the offset, D₀, may be at least partially selected based on manufacturing considerations and maintaining a certain level of structural integrity of the substrate 300 in the perforated region 310, as well as acoustic performance. In general, it may be desirable to have the pitch be as small as possible to obtain a higher open area percentage, which may improve acoustic performance. However, if the pitch and/or offset are too small, it may be difficult to manufacture the substrate 300 using techniques such as injection molding, for example. Additionally, making the pitch and/or offset too large may compromise the structural integrity of the substrate 300 and reduce its ability to provide the desired mechanical support and protection discussed above. As will be appreciated by those skilled in the art, given the benefit of this disclosure, the plurality of apertures 312 may be arranged in a variety of patterns, which may be regular or irregular. As noted above, in examples in which the substrate 300 is configured as a dual-band acoustic filter, it may be beneficial to arrange the plurality of apertures 312 in a regular pattern; however, in other examples, the pattern may be irregular. Further, the number, size, and pitch of the apertures 312 may be varied in different examples.

FIGS. 5 and 6 illustrate a substrate 300a and a substrate 300b, respectively, that are additional examples of the substrate 300 having slightly different arrangements of the plurality of apertures 312 relative to the example shown in FIG. 3. In the example shown in FIG. 5, the perforated region 310 of the substrate 300a includes additional apertures 312 relative to the example shown in FIG. 3, such that the height, Ha, of the perforated region is extended relative to the height, H, of the example shown in FIG. 3. In addition, the pattern of apertures 312 includes an additional column 318 of apertures 312 on either side of the lateral extent of the pattern of FIG. 3, such that the lateral width, Wa, is increased relative to the lateral width, W, of the example of FIG. 3 (assuming the same sized apertures 312). FIG. 6 shows another example of a substrate 300b in which the width, Wb, of the perforated region 310 is extended relative to the width, W, of the perforated region 310 in the example of FIG. 3. In addition, as may be seen by comparing FIGS. 3, 5, and 6, the patterns of apertures 312 are slightly different in each example. The pattern in the example of FIG. 5 allows for the extended height, Ha, relative to the height, H, of the example in FIG. 3. The pattern in the example of FIG. 6 allows for the extended width, Wb, relative to the width, W, of the example in FIG. 3, while also accommodating the mounting apertures 316. Those skilled in the art will appreciate that a wide variety of other patterns and arrangements of the apertures 312 may be implemented, and embodiments of the substrate 300 are not limited to the examples shown in FIGS. 3, 5, and 6.

As discussed above, the grille 424 includes a perforated region 426 including a plurality of apertures 428. In certain examples, the plurality of apertures 312 of the perforated region 310 of the substrate 300 may be larger than the plurality of apertures 428 of the perforated region 426 of the grille 424. In certain examples, each aperture 312 of the substrate 300 may have a maximum lateral dimension in a range of 2.5 to 3.75 times a maximum lateral dimension of each aperture 428 of the grille 424. For example, the apertures 428 of the grille 424 may have a diameter (or maximum lateral dimension in the case of non-round apertures) in a range of 0.8 mm-1 mm, and the apertures 312 of the substrate 300 may have a diameter (or maximum lateral dimension in the case of non-round apertures) in a range of 2-3 mm. In some instances, the substrate 300 may be configured and positioned and the grille 424 may be positioned overlaying the substrate 300 such that there is axial alignment between the apertures 428 of the grille 424 and the apertures 312 of the substrate 300. However, in other examples, the apertures 428 of the grille 424 and the apertures 312 of the substrate 300 may not be axially aligned (e.g., may be spatially staggered), or there may be alignment or partial alignment among only some of the plurality of apertures 428 and the plurality of apertures 312.

In some instances, the passage of the second acoustic output from the second audio transducer 422, and optionally that of the first acoustic output from the first audio transducer 420, can cause noise or sound distortion referred to as “air noise.” Accordingly, the size and/or pattern of the apertures 312 may be adjusted to reduce the air noise. Larger apertures 312 may reduce air noise; however, as discussed above, for other reasons it is desirable that the apertures 312 remain small. Therefore, in certain examples, the pattern of the apertures 312 can be adjusted to reduce air noise while keeping the apertures 312 in the size range needed for the desired acoustic slot-loading effect and meeting any other regulatory requirements as discussed above. For example, in certain instances, the extended height and/or width of the perforated region 310 of the substrates 300a or 300b may reduce air noise. Advantageously, where the width, W, of the perforated region 310 may be constrained to within a certain range based on the desired filtering effect of the substrate 300, the height, H, can be extended (as in the example shown in FIG. 5, for instance) to reduce air noise without substantially altering the slot-loading effect of the perforated region 310.

According to certain embodiments, the substrate 300 may have a curved surface/profile 314 such that the substrate 300 extends around at least a portion of the second audio transducer 422, as shown in FIG. 4. FIG. 7 shows a cross-sectional plan view of the substrate 300b taken along line 7-7 in FIG. 6, illustrating an example of the curvature of the substrate. Having the curved surface 314 may advantageously add to the structural support and stability provided by the substrate 300 to the grille 424. With the curved surface 314, the solid body portions 320 may extend around sides of the second audio transducer 422, “closing off” side radiation from the second audio transducer (directing the second acoustic output through the perforated region 310) and further assisting to widen the directivity of the second acoustic output, while also providing a smooth boundary for the first acoustic output from the first audio transducer 420. In addition, the curvature of the substrate 300 may assist in widening the directivity of the radiation pattern of the first audio transducer 420. For example, the directivity of the first acoustic output may be greater than 180 degrees at least in part due to the curved surface 314 of the substrate 300. Thus, as discussed above, the substrate 300 can act as a dual-band acoustic filter, modifying the directivity of both the first and second acoustic outputs.

As shown in FIGS. 4 and 7, the perforated region 310 is formed in the curved surface 314, with the plurality of apertures 312 extending through the curved surface 314. The substrate may have a thickness, T, corresponding to a depth of the apertures 312, of about 3 mm, optionally in a range of 2 mm-3.5 mm. In certain examples, the substrate 300 has a uniform thickness, T; however, in other examples, the thickness may vary between the perforated region 310 and other parts of the substrate 300. As discussed above, in some examples, the grille 424 is very thin (e.g., approximately 1 mm in thickness), and thus the substrate 300 can have a greater thickness, T, (e.g., 3 mm) to assist (along with the choice of material of the substrate) in providing structural support for the grille 424.

The substrate 300 and the plurality of apertures 312 may be formed using any of various manufacturing techniques, as will be appreciated by those skilled in the art. For example, the substrate 300 (together with the plurality of apertures) may be formed by injection molding. In other examples, the plurality of apertures 312 may be formed in a pre-made substrate 300 by milling or other hole-forming techniques. In certain examples, the apertures 312 may be formed with a varying radius along the thickness, T, of the substrate 300 (e.g., such that each aperture 312 has an “hourglass” profile). In other examples, the apertures 312 may have a uniform radius along the thickness, T, as in the example shown in FIG. 7.

Thus, aspects and embodiments provide a substrate 300 for playback devices that acts both as an acoustic filter and to provide structural support for a thin outer grille 424. As discussed above, many playback devices include thin outer grilles that are supported by an underlying substrate. By configuring the substrate 300 as discussed above, the existing component can be leveraged to advantageously widen the directivity of the sound output from the playback device 400 and enhance user experience without adding further components to the playback device 400.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the examples described herein. Accordingly, the foregoing description and drawings of various embodiments are presented by way of example only. These examples are not intended to be exhaustive or to limit any particular embodiment to the precise forms disclosed. The methods and apparatuses are capable of implementation in other embodiments and of being practiced or of being carried out in various ways. In addition, the phraseology and terminology used herein is for the purpose of description and should not be regarded as limiting. Any references to examples, components, elements, or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms. The scope of the present disclosure should be determined from proper construction of the appended claims, and their equivalents, rather than the foregoing description of examples.

1. A playback device, comprising:
an audio transducer;
a grille laterally overlaying the audio transducer, wherein the grille has a first thickness and includes a first perforated region having a first plurality of apertures extending through the grille; and
a substrate disposed between the audio transducer and the grille, wherein the substrate has a second thickness greater than the first thickness, and wherein the substrate includes a second perforated region having a second plurality of apertures extending through the substrate, the second perforated region defining an acoustic filter configured to modify a radiation pattern of an acoustic output from the audio transducer.

2. The playback device of claim 1, wherein each aperture of the first plurality of apertures has a first radius, wherein each aperture of at least a subset of the second plurality of apertures has a second radius, and wherein the first radius is less than the second radius.

3. (canceled)

4. (canceled)

5. (canceled)

6. The playback device of claim 1, wherein each aperture of the second plurality of apertures has a maximum lateral dimension in a range of 2.5 to 3.75 times a maximum lateral dimension of each aperture of the first plurality of apertures; and
wherein the first plurality of apertures is axially aligned with respect to the second plurality of apertures.

7. The playback device of claim 1, wherein the first plurality of apertures are spatially staggered with respect to the second plurality of apertures.

8. (canceled)

9. (canceled)

10. The playback device of claim 1, wherein the grille is made of plastic; and
wherein the substrate is made of glass-filled polycarbonate with a glass content in a range of 30%-40%.

11. (canceled)

12. The playback device of claim 1, wherein the substrate is curved.

13. (canceled)

14. (canceled)

15. A playback device comprising:
a housing;
a first audio transducer configured to produce a first acoustic output according to a first radiation pattern in a first frequency range;
a second audio transducer configured to produce a second acoustic output according to a second radiation pattern in a second frequency range lower in frequency than the first frequency range;
a grille extending around at least a portion of the housing, the grill including a first perforated region having a first plurality of apertures extending through the grille; and
an acoustic filter coupled to the housing and configured to modify a shape of at least one of the first radiation pattern and the second radiation pattern, the acoustic filter including a substrate having a second perforated region that defines a slot of the acoustic filter, the second perforated region including a second plurality of apertures extending through the substrate;
wherein the substrate is coupled to the housing and positioned with the second perforated region disposed in front of the second audio transducer to allow the second acoustic output to pass through the second perforated region; and
wherein the grille is positioned with a portion of the first perforated region overlaying the second perforated region of the substrate.

16. (canceled)

17. The playback device of claim 15, wherein the first frequency range includes audible frequencies above 2 kilohertz, and wherein the second frequency range includes audible frequencies below 500 hertz.

18. The playback device of claim 15, wherein the substrate has a curved surface, the first perforated region being formed in the curved surface; and
wherein the substrate includes first and second solid body portions positioned on either side of the first perforated region and extending laterally around the second audio transducer, the first audio transducer being positioned at least partially above the first solid body portion.

19. (canceled)

20. (canceled)

21. (canceled)

22. (canceled)

23. (canceled)

24. The playback device of claim 15, wherein the substrate is made of glass-filled polycarbonate with a glass content in a range of 30%-40%; and
wherein the grille is made of plastic.

25. The playback device of claim 15, wherein a lateral width of the slot is less than an outer diameter of the second audio transducer.

26. The playback device of claim 15, wherein the grille has a first axial thickness and wherein the substrate has a second axial thickness that is greater than the first axial thickness.

27. (canceled)

28. (canceled)

29. (canceled)

30. A playback device comprising:
a housing;
a first audio transducer configured to produce a first acoustic output in a first frequency range;
a second audio transducer configured to produce a second acoustic output in a second frequency range lower in frequency than the first frequency range;
a grille laterally overlaying the first and second audio transducers and extending around at least a portion of the housing, wherein the grille includes a first perforated region having a first plurality of apertures extending through the grille; and
a substrate axially disposed between the second audio transducer and the grille and coupled to the housing, wherein the substrate includes a second perforated region including a second plurality of apertures extending through a surface of the substrate and collectively defining an acoustic filter slot having a lateral width and a height, the lateral width being less than an outer diameter of the second audio transducer,
wherein the substrate is positioned with the second perforated region overlaying the second audio transducer; and
wherein the grille is positioned with a portion of the first perforated region overlaying the second perforated region of the substrate.

31. The playback device of claim 30, wherein the surface of the substrate is curved; and
wherein the substrate further includes first and second solid body regions disposed laterally on either side of the second perforated region, the substrate being configured as a slot-loaded acoustic filter that modifies dispersion of each of the first and second acoustic outputs.

32. (canceled)

33. The playback device of claim 31, wherein the first and second solid body portions extend laterally around the second audio transducer.

34. The playback device of claim 31, wherein the slot-loaded acoustic filter provides greater than 180 degrees directivity of the first acoustic output.

35. The playback device of claim 30, wherein the substrate is made of glass-filled polycarbonate with a glass content in a range of 30%-40%; and
wherein the grille is made of plastic.

36. (canceled)

37. (canceled)

38. (canceled)

39. The playback device of claim 30, wherein the lateral width of the acoustic filter slot is less than an outer diameter of the second audio transducer.

40. The playback device of claim 30, wherein the grille has a first axial thickness and wherein the substrate has a second axial thickness that is greater than the first axial thickness.

41. (canceled)

42. (canceled)

43. The playback device of claim 30, wherein the first frequency range includes audible frequencies above 2 kilohertz, and wherein the second frequency range includes audible frequencies below 500 hertz.

44. (canceled)

45. (canceled)

46. (canceled)

47. (canceled)

48. (canceled)

49. (canceled)

50. (canceled)

51. (canceled)
